(19) United States
(12) Patent Application Publication
(10) Pub. No.: US 2006/0140122 A1
(43) Pub. Date: Jun. 29, 2006

(54) Link retry per virtual channel

(75) Inventors: Robert A. Shearer, Rochester, MN (US); Martha E. Voytovich, Rochester, MN (US)

Correspondence Address: IBM CORPORATION;DEPT 917, 3605 HIGHWAY 52 NORTH, ROCHESTER, NY, 55901-7829, US

(73) Assignee: International Business Machines Corporation, Armonk, NY (US)

(21) Appl. No.: 11/023,707

(22) Filed: Dec. 28, 2004

(51) Int. Cl. H04L 1/00

(52) U.S. Cl. 370/236

(57) ABSTRACT

Methods and apparatus that allow lost packets on one virtual channel to be retried without requiring all subsequently issued packets, sent over other virtual channels, to be retried. In other words, packet retries may be performed on a “per virtual channel” basis. As a result, other virtual channels, not experiencing lost packets, may not suffer reductions in their bandwidth due to a lost packet occurring on another virtual channel.

### BACKGROUND OF THE INVENTION

1. Field of the Invention

The present invention generally relates to exchanging data on a bus between devices and, more particularly, to exchanging data between devices on a single bus using multiple virtual channels.

2. Description of the Related Art

A system on a chip (SOC) generally includes one or more integrated processor cores, some type of embedded memory, such as a cache shared between the processors cores, and peripheral interfaces, such as external bus interfaces, on a single chip to form a complete (or nearly complete) system. Often SOCs communicate with other devices, such as a memory controller or graphics processing unit (GPU), by exchanging data packets over an external bus. Often, the devices will communicate over a single external bus utilizing muliple streams of data, commonly referred to as virtual channels.

Virtual channels are referred to as virtual because, as multiple virtual channels may utilize a common physical interface (e.g., the bus), they appear and act as separate channels. Virtual channels may be implemented using various logic components (e.g., switches, multiplexors, etc.) utilized to route data, received over the common bus, from different sources to different destinations, in effect, as if there were separate physical channels between each source and destination. An advantage to utilizing virtual channels is that various processes utilizing the data streamed by the virtual channels may operate in parallel which may improve system performance (e.g., while one process is receiving/sending data over the bus, another process may be manipulating data and not need the bus).

In a system that utilizes multiple virtual channels to exchange data over a common bus, data is typically exchanged using data packets sent over the virtual channels. For example, these packets may include command packets, such as packets to request data and packets to respond with requested data. When a transmitting device sends a packet, the receiving device typically replies with a packet acknowledging the packet was received. Occasionally, due to some type of bus error, a packet can be lost, which is typically detected when a reply packet acknowledging that packet is not received in a given amount of time.

In conventional systems, the loss of a data packet requires all data packets, for all virtual channels, that have been sent after the lost data packet to also be retransmitted (or “retried”). Unfortunately, even those commands issued by virtual channels that did not experience the lost packet are retried. In other words, a lost packet on a single virtual channel can adversely affect the performance of the entire physical link.

Accordingly, what is needed is methods and systems to reduce the impact that a lost packet on one virtual channel has on other virtual channels.

### SUMMARY OF THE INVENTION

The present invention generally provides methods and systems that reduce the impact that a lost packet on one virtual channel has on other virtual channels.

One embodiment provides a method of communicating with an external device over a bus utilizing a plurality of virtual channels, each virtual channel representing a stream of data exchanged on the bus. The method generally includes maintaining at least one link retry timer for each virtual channel used to send data packets to the external device, initializing a first link retry timer in conjunction with sending a first data packet to the external device over a corresponding first virtual channel, and resending one or more previously sent and unacknowledged data packets to the external device over the corresponding virtual channel, in response to expiration of the first link retry timer.

Another embodiment provides an integrated circuit (IC) device. The device generally includes one or more processor cores, a bus interface for transferring data to and from an external device via an external bus, and link retry logic circuitry. The link retry logic circuitry is generally configured to maintain at least one link retry timer for each of a plurality of virtual channels used to send data packets from the one or more processing cores to the external device via the bus interface and initiate the resending of data packets over a virtual channel in response to detecting expiration of a corresponding link retry timer.

Another embodiment provides a system generally including a bus, one or more external devices, and a system on a chip (SOC). The SOC has one or more processor cores and link retry logic circuitry configured to maintain at least one link retry timer for each of a plurality of virtual channels used to send data packets from the one or more processing cores to the one or more external devices via the external bus and initiate the resending of data packets over a virtual channel in response to detecting expiration of a corresponding link retry timer.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system including a central processing unit (CPU), in which embodiments of the present invention may be utilized.

FIG. 2A is a block diagram of components of the CPU, according to one embodiment of the present invention.

FIG. 2B illustrates an exemplary buffer used to track commands sent over a virtual channel, according to one embodiment of the present invention.

FIG. 3 is a general flow diagram of exemplary operations according to one embodiment of the present invention.

FIG. 4 is a more detailed flow diagram of exemplary operations according to one embodiment of the present invention.

### DETAILED DESCRIPTION OF THE PREFERRED EMBODIMENTS

Embodiments of the present invention generally allow lost packets on one virtual channel to be retried without requiring all subsequently issued packets, sent over other virtual channels, to be retried. In other words, command retries may be performed on a “per virtual channel” basis. As a result, these other virtual channels may not suffer reductions in their bandwidth due to a lost packet occurring on another virtual channel. For some embodiments, at least one link retry timer may be maintained for each of a plurality of virtual channels used to send data packets to an external device.

As used herein, the term virtual channel generally refers to a stream of data from one component to another. Virtual channels may be implemented using various logic components (e.g., switches, multiplexors, etc.) utilized to route data, received over a common bus, from different sources to different destinations, in effect, as if there were separate physical channels between each source and destination.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

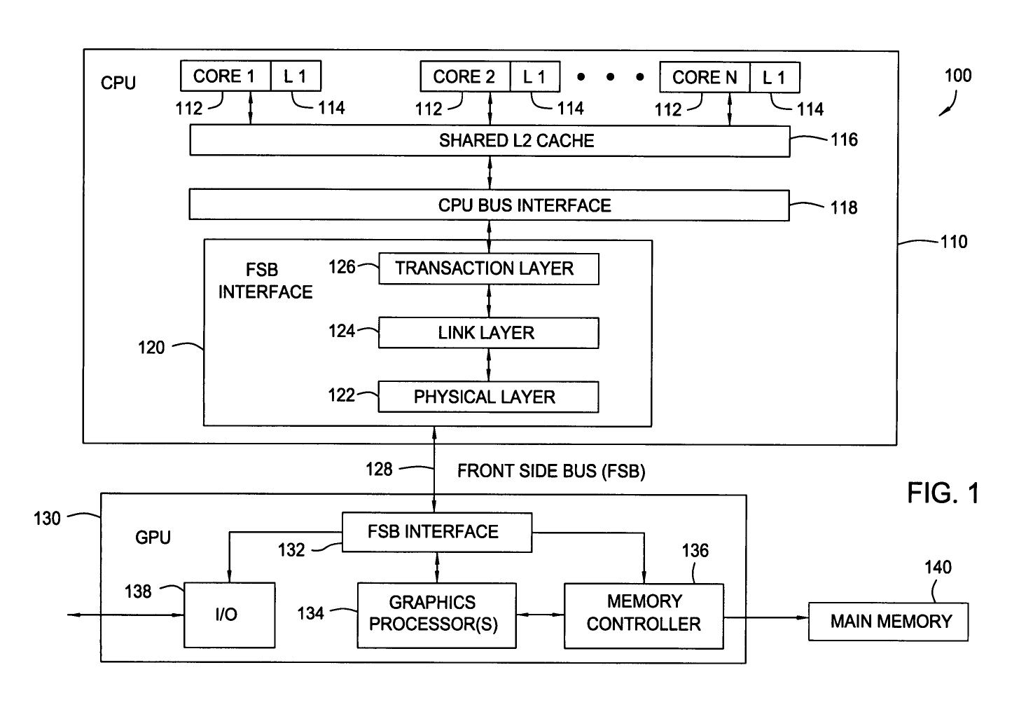

FIG. 1 illustrates an exemplary computer system 100 including a central processing unit (CPU) 110, in which embodiments of the present invention may be utilized. As illustrated, the CPU 110 may include one or more processor cores 112, which may each include any number of different type functional units including, but not limited to arithmetic logic units (ALUs), floating point units (FPUs), and single instruction multiple data (SIMD) units. Examples of CPUs utilizing multiple processor cores include the Power PC line of CPUs, available from IBM.

As illustrated, each processor core 112 may have access to its own primary (L1) cache 114, as well as a larger shared secondary (L2) cache 116. In general, copies of data utilized by the processor cores 112 may be stored locally in the L2 cache 116, preventing or reducing the number of relatively slower accesses to external main memory 140. Similarly, data utilized often by a processor core may be stored in its L1 cache 114, preventing or reducing the number of relatively slower accesses to the L2 cache 116.

The CPU 110 may communicate with external devices, such as a graphics processing unit (GPU) 130 and/or a memory controller 136 via a system or frontside bus (FSB) 128. The CPU 110 may include an FSB interface 120 to pass data between the external devices and the processing cores 112 (through the L2 cache) via the FSB 128. An FSB interface 132 on the GPU 130 may have similar components as the FSB interface 120, configured to exchange data with one or more graphics processors 134, input output (I/O) unit 138, and the memory controller 136 (illustratively shown as integrated with the GPU 130).

As illustrated, the FSB interface 120 may include a physical layer 122, link layer 124, and transaction layer 126. The physical layer 122 may include hardware components for implementing the hardware protocol necessary for receiving and sending data over the FSB 128. The physical layer 122 may exchange data with the link layer 124 which may format data received from or to be sent to the transaction layer 126.

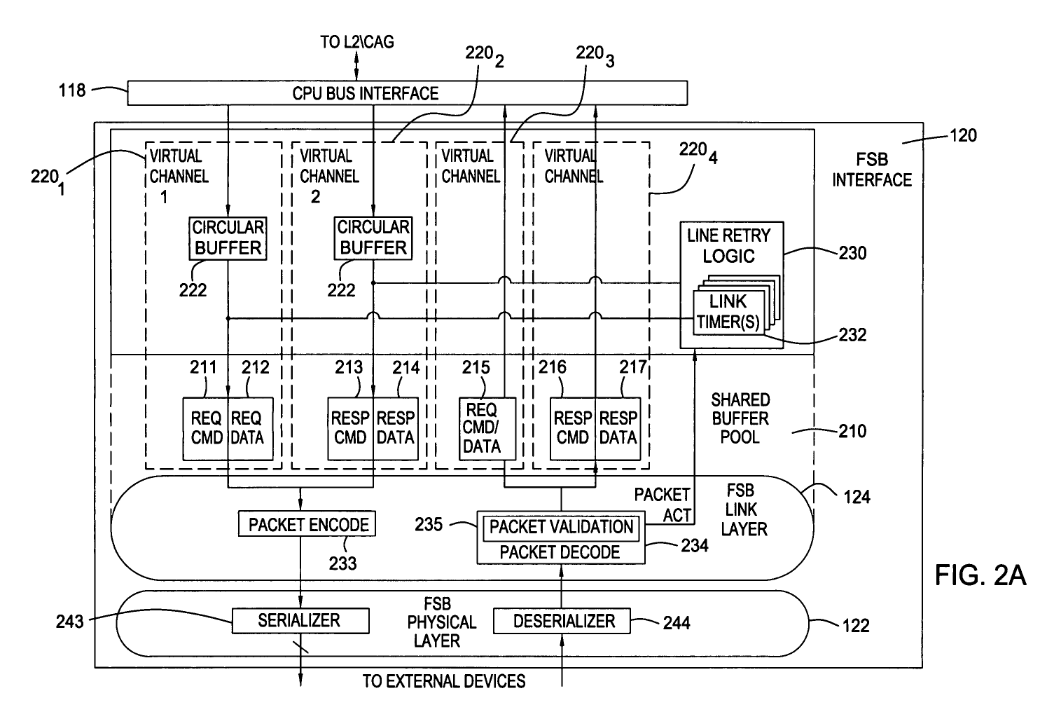

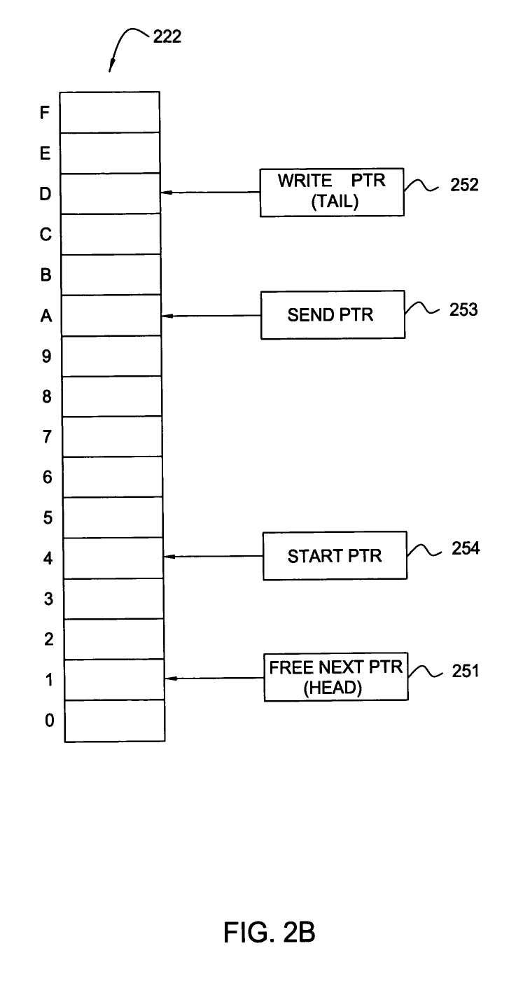

As illustrated, the transaction layer 126 may exchange data with the processor cores 112 via a CPU bus interface 118. For some embodiments, data may be sent over the FSB as packets. Therefore, the link layer 124 may contain circuitry configured to encode into packets or “packetize” data received from the transaction layer 126 and to decode packets of data received from the physical layer 122, which may include a serializer 243 and a de-serializer 244 (shown in FIG. 2A) for generating and receiving such packets, respectively.

As shown in FIG. 2A, a plurality of virtual channels 220 may be established to exchange data between the processor cores 112 and external devices. Illustratively, the virtual channels include two (CPU controlled) virtual channels 220₁ and 220₂ on the transmit side (e.g., to transmit data from the CPU to the GPU) and two (GPU controlled) virtual channels 220₃ and 220₄ on the receive side (e.g., to receive data transmitted from the GPU to the CPU). The virtual channels 220 may improve overall system performance, for example, allowing one processing core to transfer data while another processes data (and is not transferring data).

As illustrated, the virtual channels may be used to transfer data into and out of a shared buffer pool 210. Each virtual channel may be allocated a different portion of the shared buffer pool. For example, the first transmit-side virtual channel 220₁ may be allocated and utilize buffers 211 and 212 to hold request commands and data that will be sent in packets to an external device, while the second transmit-side virtual channel 220₂ may be allocated and utilize buffers 213 and 214 to hold response commands and data to be sent the external device (e.g., in response to commands received therefrom). Similarly, the first receive-side virtual channel 220₃ may be allocated and utilize buffer 215 to hold request commands and data received from the external device, while the second receive-side virtual channel 220₄ may be allocated and utilize buffers 216 and 217 to hold response commands and data received from the external device.

For some embodiments, each data packet sent to the external device on a virtual channel may be assigned a sequence count. Acknowledgement packets received from the external device for a particular packet may contain this assigned count to indicate that packet has been successfully received by the external device. Each virtual channel may utilize a unique sequence, different from those used by other virtual channels.

Each transmitting device may have a data structure that is used to retain pertinent command information in case packet retries are required on its transmit virtual channels. For example, this data structure may retain (or buffer) a series of packets that have been sent. In the event any of these packets are not acknowledged in some predetermined period of time, that packet and all subsequent packets may be retried. As illustrated, for some embodiments, this data structure may be implemented using a circular buffer 222. The circular buffer 222 may provide a straightforward method for matching commands with their corresponding sequence count. A given command packet may always have the same index in the queue, and various pointers into the circular buffer will wrap around as they reach the top (hence the term circular). Similar data structures operating in a similar manner may also be utilized on the GPU side, to track data packets sent to the CPU over virtual channels 220₃ and 220₄.

For each circular buffer 222, a set of pointers may be maintained that indicate important buffer entries. For example, as illustrated in FIG. 2B, these pointers may include pointers that indicate the earliest location in the queue containing a data packet that has not been freed (i.e., the earliest location/entry that is not ready to accept another entry) and the next position in the buffer that can be written into, referred to herein as a head pointer 251 and tail pointer 252, respectively. The pointers may also include a pointer that indicates the sequence count of the next packet to send (send pointer 253) and a pointer (start pointer 254) to the beginning of outstanding commands (commands that have been sent but not yet acknowledged). As will be described in greater detail below, for some embodiments, these pointers may be used to determine which commands should be retried in the event a packet sent on a corresponding virtual channel is lost (not acknowledged).

### Separate Link Retry Timers

As previously described, occasionally data packets sent the external device over one of the virtual channels may be lost (e.g., due to a bit error resulting in a bad checksum), as indicated by the failure to receive an acknowledgement from a receiving device. Referring back to FIG. 2A, embodiments of the present invention may include link retry logic 230 configured to maintain separate link retry timers 232 for each transmit-side virtual channel 220₁ and 220₂. Similar logic may also be utilized on the GPU side, to maintain separate link retry timers for each (GPU) transmit-side virtual channel 220₃ and 220₄. For some embodiments, the link retry logic 230 may monitor the link retry timers 232 and, if one expires, generate a signal to prompt resending of one or more unacknowledged packets previously sent over a corresponding virtual channel. As illustrated, separate logic in the link layer 124 may provide an indication to link retry logic 230 of packet acknowledgements received from the external device. In response, the link retry logic 230 may reinitialize corresponding link retry timers As will be described below, utilizing separate link retry timers 232, lost packets may be retried only for a virtual channel experiencing lost packets without adversely affecting other virtual channels.

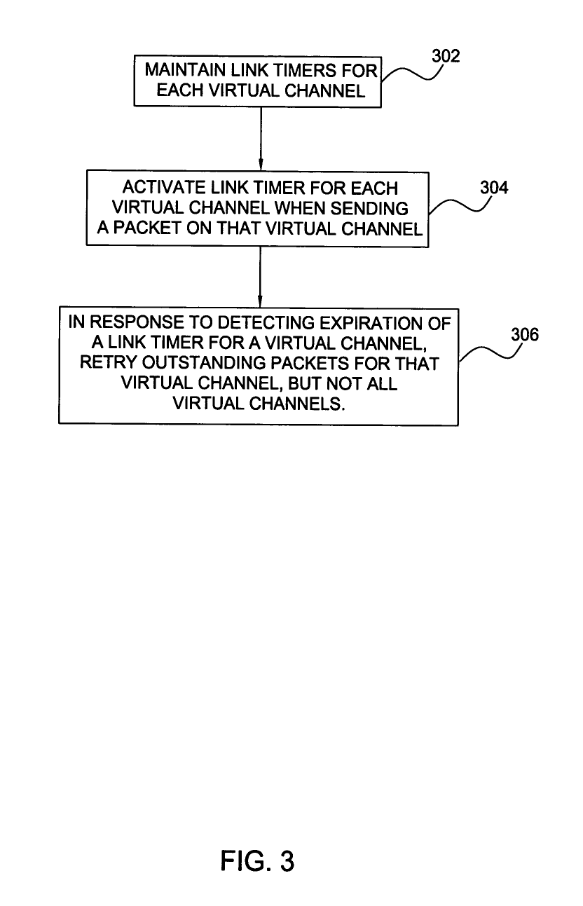

FIG. 3 illustrates exemplary operations 300 that may be performed, for example, by the link retry logic 230 to retry packets only for those virtual channels that have lost packets. The operations begin, at step 302, by maintaining separate link timers for each virtual channel. For some embodiments, a single link timer 232 may be maintained for each virtual channel 220. For other embodiments, multiple link timers may be maintained for each virtual channel (e.g., the multiple link timers may include a link timer for each outstanding packet).

Each link timer may be initiated and reset in conjunction with the sending of packets and receiving of corresponding acknowledgement packets, respectively. For example, at step 304, a link timer for a virtual channel may be activated when sending a packet on that virtual channel. In other words, the link timer may be initialized with the maximum amount of time in which a packet must be acknowledged before a sent packet is declared lost. For some embodiments, this maximum acknowledgement time may be programmable, for example, by writing to a control register.

At step 306, in response to detecting expiration of a link timer for a corresponding virtual channel, outstanding packets for that virtual channel, but not all virtual channels, may be retried. In other words, other virtual channels that have not experienced lost packets may continue to send packets without retrying outstanding packets, which may increase overall system bandwidth.

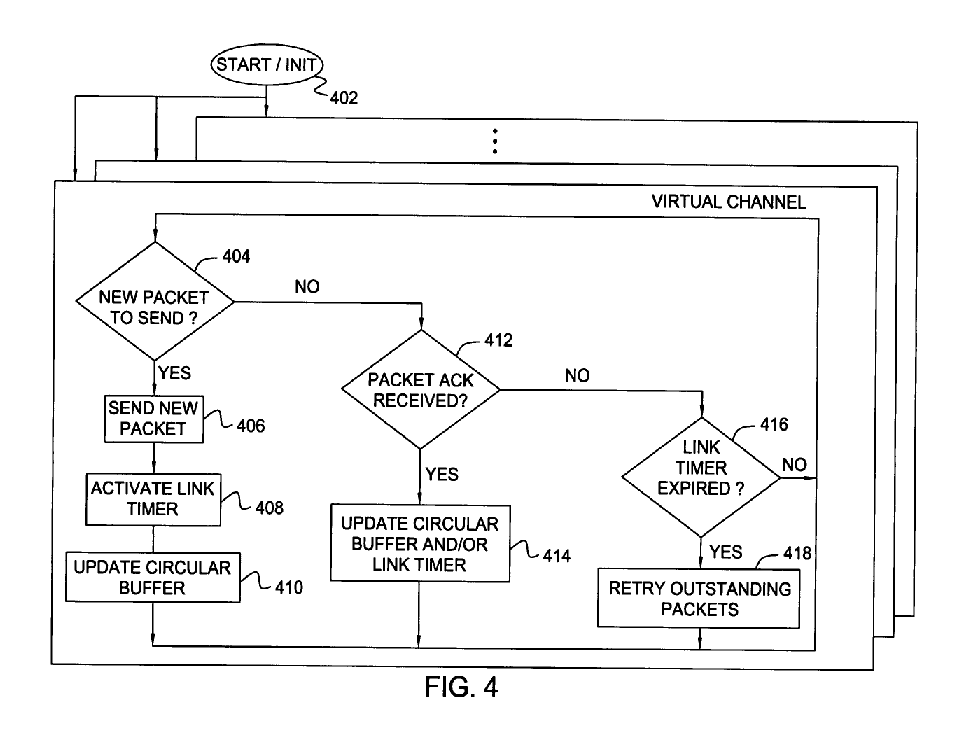

For some embodiments, link retry logic 230 may perform operations for each virtual channel, for example, according to the exemplary operations 400 of FIG. 4. The operations 400 begin, at step 402, for example, upon a power-on or other type of reset condition. A loop of operations 404-418 is then performed for each virtual channel. While illustratively shown as being performed sequentially, the tests performed in decision blocks 404, 412, and 416 may actually be performed in parallel. In some cases, one or more of the operations may actually be triggered by an interrupt (e.g., generated when a packet is received or a link timer expires).

Regardless, if a new packet is to be sent on a virtual channel, as determined at step 404, the new packet is sent, at step 406, and a link timer for that virtual channel is activated, at step 408. For some embodiments, the circular buffer may be updated, at step 410. For example, the command sent at step 406 may have been indicated by the send pointer 253, which may be subsequently incremented. As previously described, for some embodiments, a separate link timer may not be maintained for each packet sent. Therefore, rather than reset the link timer with each packet sent, the link retry logic may contain additional logic to determine when to reset\initialize the link timer. For example, a single common link timer may be reset after receiving acknowledge packets (with the link timer used to monitor acknowledgement timeout of a subsequently sent packet).

If an acknowledgement packet is received, as determined at step 412, the circular buffer and/or link timer may be updated, at step 414. For example, because an outstanding packet has been acknowledged, the start pointer 254 used to indicate the start of outstanding packets in the circular buffer 222 may be incremented to point to a subsequently issued outstanding packet. If a single link timer is utilized for each virtual channel, the link timer may be re-initialized, as described above, to begin monitoring for an acknowledgement of this subsequently issued outstanding packet.

If an acknowledgement packet is not received before a corresponding link timer has expired, as determined at step 416, outstanding packets for this virtual channel may be retried, at step 418. For some embodiments, all packets that have been sent on this virtual channel since the unacknowledged packet and including the unacknowledged packet may be retried. The unacknowledged packets that should be retried may be determined by examining pointers maintained by the circular buffer 222.

For example, if the Start Pointer 254 points to the earliest command not acknowledged and the Send Pointer 253 points to the next command to send, packets starting with that pointed to by Start Pointer 254 up to the packet just before the packet pointed to by Send Pointer (i.e., Send Pointer—1) may be considered outstanding and may be retried. For other embodiments that maintain a separate link timer for each outstanding data packet on a particular virtual channel, only those commands sent after a command whose corresponding link timer has expired (as well as that command) may need to be retried. In either case, only outstanding data packets sent over virtual channels experiencing lost packets may be resent.

### CONCLUSION

By maintaining one or more link timers for each virtual channel, only those virtual channels experiencing lost packets may require packets to be retried. Other virtual channels, not experiencing lost packets, may avoid having to retry packets, thereby increasing overall system bandwidth.

While the foregoing is directed to embodiments of the present invention, other and further embodiments of the invention may be devised without departing from the basic scope thereof, and the scope thereof is determined by the claims that follow.

What is claimed is:

1. A method of communicating with an external device over a bus utilizing a plurality of virtual channels, each virtual channel representing a stream of data exchanged on the bus, comprising:
maintaining at least one link retry timer for each of a plurality of virtual channels used to send data packets to the external device;
initializing a first link retry timer in conjunction with sending a first data packet to the external device over a corresponding first virtual channel; and
resending one or more previously sent and unacknowledged data packets to the external device over the corresponding virtual channel in response to detecting the first link retry timer has expired.

2. The method of claim 1, wherein maintaining at least one link retry timer for each virtual channel used to send data packets to the external device comprises maintaining a single link retry timer for each virtual channel used to send data packets to the external device.

3. The method of claim 2, further comprising reinitializing a single link retry timer for a virtual channel in response to receiving, from the external device, a packet acknowledging receipt of a data packet sent over that virtual channel.

4. The method of claim 1, further comprising updating one or more pointers into a circular buffer for the first virtual channel in conjunction with sending the first data packet to the external device.

5. The method of claim 4, wherein resending at least the first data packet to the external device over the corresponding virtual channel comprises resending a plurality of data packets indicated by the one or more pointers into the circular buffer.

6. The method of claim 5, wherein:
the one or more pointers comprise a first pointer indicative of the earliest unacknowledged data packet sent; and
resending a plurality of packets comprises resending all packets from the earliest unacknowledged data packet to the last data packet sent.

7. The method of claim 6, further comprising determining the last data packet sent based on a second pointer indicative of the next data packet to be sent.

8. An integrated circuit (IC) device, comprising:
one or more processor cores;
a bus interface for transferring data to and from an external device via an external bus; and
link retry logic circuitry configured to maintain at least one link retry timer for each of a plurality of virtual channels used to send data packets from the one or more processing cores to the external device via the bus interface and initiate the resending of data packets over a virtual channel in response to detecting expiration of a corresponding link retry timer.

9. The device of claim 8, wherein the link retry logic circuitry is configured to generate a signal prompting one or more unacknowledged data packets to be resent over a virtual channel, in response to expiration of a link retry timer corresponding to that virtual channel.

10. The device of claim 8, wherein the link retry logic maintains a single link retry timer for each virtual channel used to send data packets to the external device.

11. The device of claim 8, wherein the link retry logic is configured to initialize a link retry timer in conjunction with a data packet being sent over a corresponding virtual channel.

12. The device of claim 8, wherein the link retry logic is configured to re-initialize a link retry timer in conjunction with receipt of an acknowledge packet, from the external device, acknowledging a data packet previously sent over a corresponding virtual channel.

13. The device of claim 8, further comprising:
a circular buffer for each virtual channel used to send data packets to the external device, the circular buffer containing entries indicating a set of data packets previously sent or to be sent to the external device; and
wherein the link retry logic is configured to determine which data packets to resend based on pointers into the circular buffer.

14. The device of claim 13, wherein the link retry logic is further configured to determine which data packets should be resent over a virtual channel by examining one or more pointers into the circular buffer for that virtual channel.

15. The device of claim 14, wherein the link retry logic is configured to determine which data packets should be resent by examining a first pointer indicative of the earliest unacknowledged data packet sent over that virtual channel.

16. A system, comprising:
at least one bus;
one or more external devices; and
a system on a chip (SOC) having one or more processor cores and link retry logic circuitry configured to maintain at least one link retry timer for each of a plurality of virtual channels used to send data packets from the one or more processing cores to the one or more external devices via the external bus and initiate the resending of data packets over a virtual channel in response to detecting expiration of a corresponding link retry timer.

17. The system of claim 16, wherein the link retry logic circuitry is configured to maintain a single link retry timer for each virtual channel used to send data packets from the SOC to the one or more external devices.

18. The system of claim 16, wherein the one or more external devices comprises a graphics processing unit (GPU) and a memory controller.

19. The system of claim 18, wherein the memory controller is integrated with the graphics processing unit.

20. The system of claim 16, wherein the system is a gaming system and the virtual channels are used to send data packets containing graphical data from the SOC to the GPU.
